(19) United States
(12) Patent Application Publication
(10) Pub. No.: US 2016/0091989 A1
(43) Pub. Date: Mar. 31, 2016

(54) Foot Operated Computer Control Device to Remotely Access Patient Information During Robotic Surgeries

(71) Applicant: Shefali Ashish Pandya, El Dorado Hills, CA (US)

(72) Inventor: Shefali Ashish Pandya, El Dorado Hills, CA (US)

(21) Appl. No.: 14/503,117

(22) Filed: Sep. 30, 2014

(51) Int. Cl. G06F 3/0354

(52) U.S. Cl. CPC G06F 3/03543

(57) ABSTRACT

This patent describes a foot controlled mouse for ease of access to information on a computer during operations or procedures during which it is impractical for a doctor, surgeon, or dentist to have access to a keyboard. It operates through the use of pressure sensors.

### RELATED APPLICATIONS

Priority is claimed to Provisional Application Ser. No. 61/960,867 filed on Sep. 30, 2013 entitled A foot Operated Computer Control Device to Remotely Access Patient Information During Robotic Surgeries which is incorporated fully herein.

### BACKGROUND OF THE INVENTION

This invention relates generally to a electronic computer mouse that can be operated using the foot.

### SUMMARY OF THE INVENTION

This device is a foot controlled mouse for ease of access to information on a computer during operations or procedures during which it is impractical for a doctor, surgeon, or dentist to have access to a keyboard. It operates through the use of four pressure sensors placed one each to a quadrant of the platform (top right, top left, bottom right, bottom left). Combinations of pressure on these four sensors are used to convey commands to the computer to move the mouse, type numbers, or pull up a keyboard.

### BRIEF DESCRIPTION OF THE DRAWINGS

FIG. 1 illustrates the internal components of a pressure controlled mouse.

FIG. 2 illustrates the internal components of the right and left controls of a pressure controlled mouse.

FIG. 3 illustrates the outer view of a pressure controlled mouse.

FIG. 4 illustrates wireless connection between the pressure controlled mouse and the computer.

FIG. 5 illustrates foot positioning on the top view of a wireless pressure controlled mouse.

FIG. 6 illustrates the usage of the pressure controlled mouse during robotic surgery.

FIG. 7 illustrates Pressure Controlled Mouse-Usage during a Dental Examination

FIG. 8 illustrates Pressure Controlled Mouse Usage with a Controller during a Dental Examination

FIG. 9 illustrates Pressure Controlled Mouse Usage with Patient Chart during a Dental Examination

### DESCRIPTION

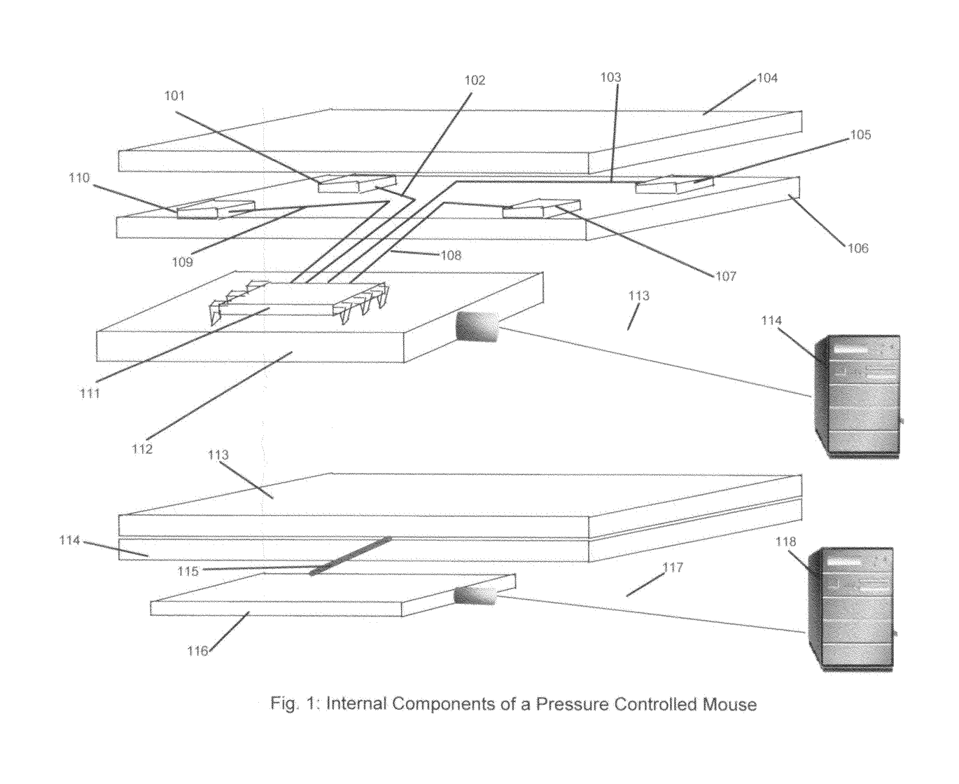

FIG. 1 illustrates the four pressure sensors (101, 105, 107, 110) inside the pressure controlled mouse. 102, 103, 108, and 109 illustrate the connections between the sensors and the processing unit (111). 104 represents the cover for the apparatus through which pressure is sensed. 106 illustrates the plate on which the sensors are mounted. 112 illustrates the plate on which the integrated circuit chip is mounted. 113 illustrates the wire connecting the apparatus to the computer (114). These pressure sensors are used to detect different levels of pressure on combinations of sensors that are used to perform functions with the mouse including but not limited to moving and typing.

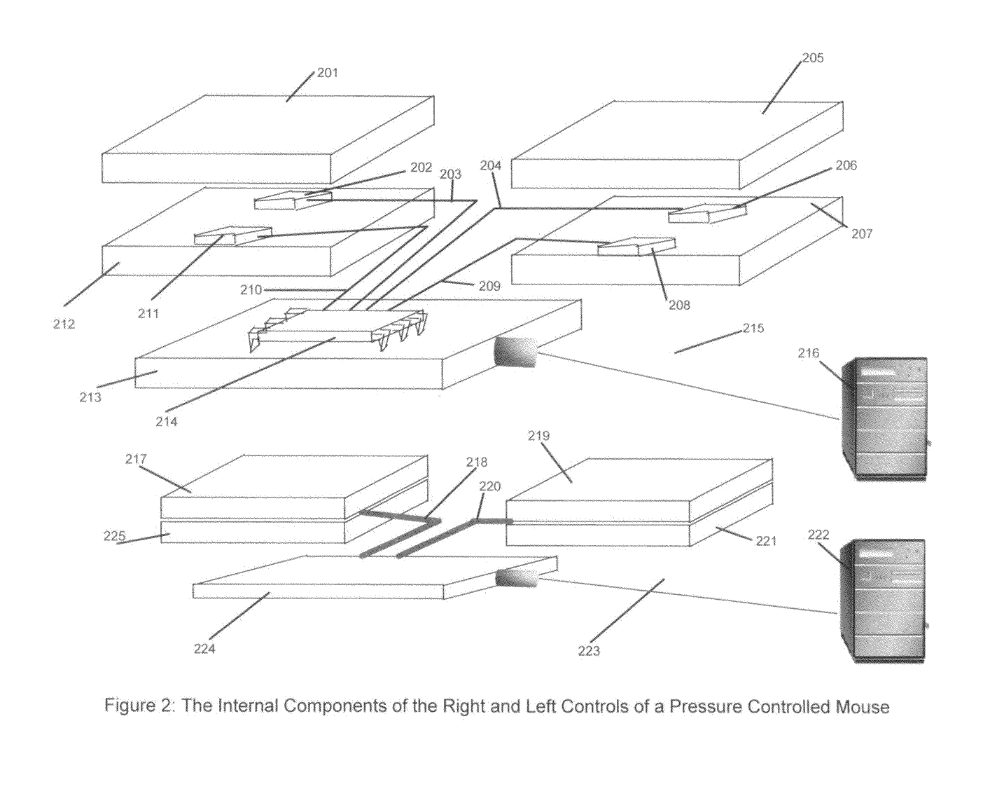

FIG. 2 illustrates the internal components of the right and left controls of a pressure controlled mouse. The four pressure sensors are illustrated by 202, 206, 208, and 211. The wires connecting the sensors to the integrated circuit chip (214) are 203, 204, 209, and 210. The left sensors are covered by plate 201 and mounted on plate 212. The right sensors are covered by plate 205 and mounted on plate 207. The integrated circuit chip is mounted on plate 213. 215 illustrates the wire connecting the circuit chip to the computer (216). The values detected by the pressure sensor are processed by the circuit and then sent to the computer through the wires to give commands.

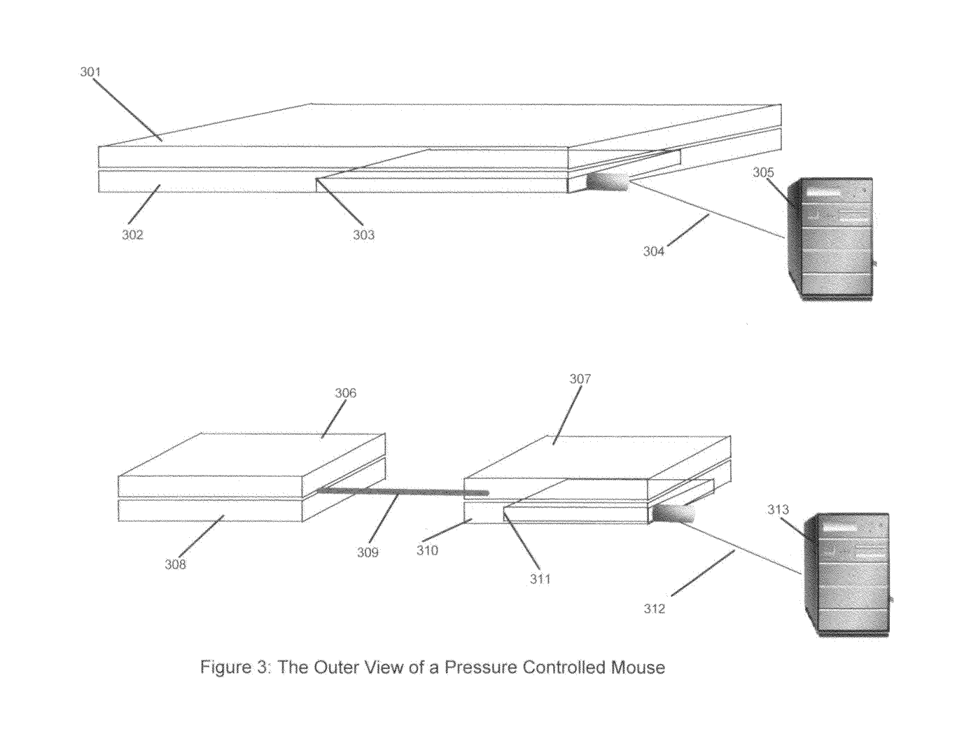

FIG. 3 represents the outer view of the pressure controlled mouse. 301 is the plate covering the apparatus. The feet rest on this plate. 302 illustrates the plate on which the sensors rest. 303 represents the plate on which the integrated circuit chip rests. The lower section of the figure illustrates how the figure would be set up if the right and left sensors were separated from each other. 306 (left) and 307 (right) are the plates covering the sensors. 308 (left) and 310 (right) are the plates on which the sensors rest. 311 is the plate on which the integrated circuit chip rests, inside the right half of the unit. The right and left sides are separated in this figure to represent that they can be adjusted for the comfort or practicality of the person using them. 304 and 312 represent the wire connecting the apparatus to the computer (305/313).

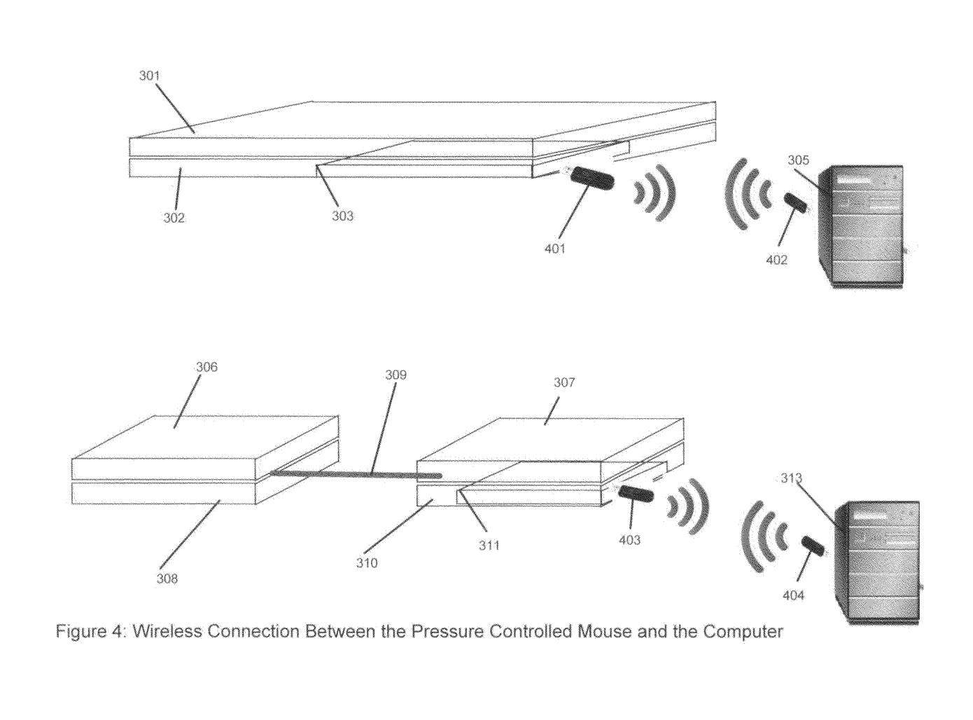

FIG. 4 illustrates the wireless connection between the pressure controlled mouse and the computer. 401 and 403 represent the wireless network connector on the apparatus itself. 402 and 404 illustrate the wireless network connector in the computer with which the apparatus exchanges information. It performs exactly the same function as the wires but through a different medium that could prove more convenient in certain environments. For example, cables on the floor during a surgery that doctors may be walking in and out of could pose a potential danger. The purpose of this is to reduce risk and increase convenience.

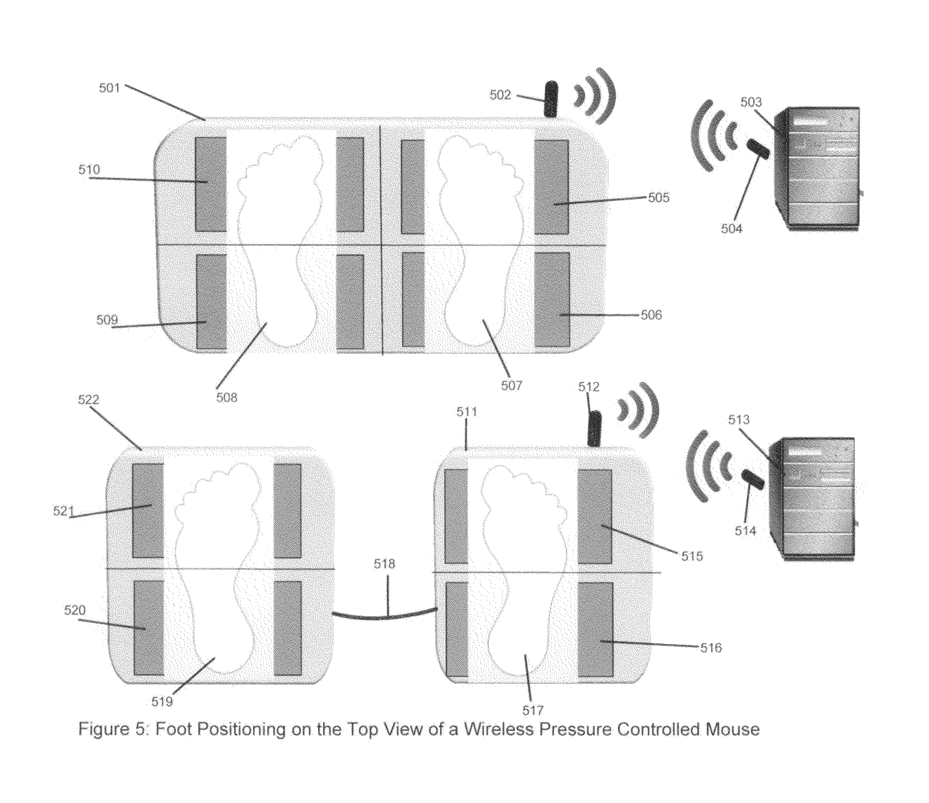

FIG. 5 illustrates the foot positioning on the top view of the wireless pressure controlled mouse. 501 is the plate that covers the top of the apparatus. 510 and 521 represent the sensitive area over the top left sensor that will respond if pressed. 505 and 515 illustrate a similar area over the top right sensor; 506 and 516 illustrate a similar area over the bottom right sensor; 509 and 520 illustrate a similar area over the bottom left sensor. 507 represents the positioning of the right foot. 508 represents the positioning of the left foot. 502 and 504 (with the same functions as 512 and 514 respectively) represent the areas of wireless connection between the apparatus and the computer (503/513). The bottom section of FIG. 5 illustrates how the apparatus would look if the right and left sides were separated because keeping them on one plate creates restriction. 522 is the plate that covers the apparatus with the left sensors; 511 illustrates the plate that covers the apparatus with the right sensors. 518 illustrates the wire connecting the two parts of the pressure controlled mouse.

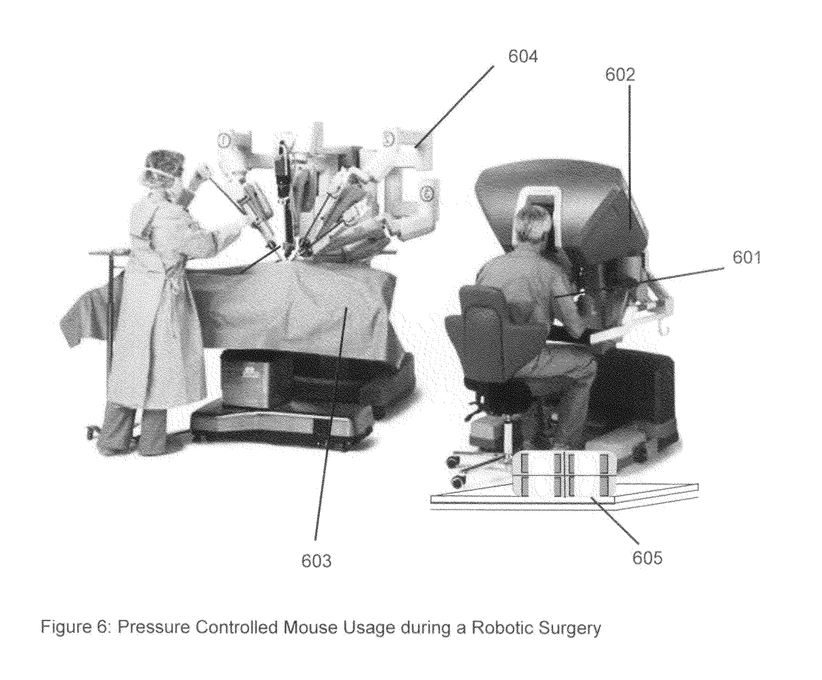

FIG. 6 illustrates the usage of the pressure controlled mouse during robotic surgery. The surgery is being performed on the patient (603) by the doctor (601) through the computer monitor (602) that controls the robotic arm (604). The pressure controlled mouse is at the doctor's feet (605).

The various functions of the device are listed in the tables below.

D indicates a double tap, and 0 indicates no pressure on the sensor whereas I's indicate the degree of the pressure of a single tap. “I” represents a light tap and each extra “I” will denote increasing amounts of pressure. The range of pressure on the sensors can be measured in values from 0 to 99. This can further be divided into quarters with ranges 0-24, 25-49, 50-74, and 75-99. These divisions can be calibrated to the person using this device, and can be assigned different functions; for example, a very light touch may indicate a click whereas heavier pressure may indicate movement of the mouse on the computer screen.

This table illustrates a way of encoding the pressure readings of the sensors into commands, in this illustration, numbers.

| | | | Bottom | |
|---|---|---|---|---|
| Top Right | Bottom Right | Top Left | Left | |
| Sensor | Sensor | Sensor | Sensor | Action |
| 0 | 0 | 0 | 0 | No action |
| I | 0 | 0 | 0 | Enter the number 0 |
| 0 | I | 0 | 0 | Enter the number 1 |
| 0 | 0 | I | 0 | Enter the number 2 |
| 0 | 0 | 0 | I | Enter the number 3 |
| I | I | 0 | 0 | Enter the number 4 |
| 0 | 0 | I | I | Enter the number 5 |
| I | 0 | I | 0 | Enter the number 6 |
| 0 | I | 0 | I | Enter the number 7 |
| 0 | I | I | 0 | Enter the number 8 |
| I | 0 | 0 | I | Enter the number 9 |

The following table describes the movements and functions of the mouse icon on the computer screen as usually performed by an external mouse or mousepad.

| | | | Bottom | |
|---|---|---|---|---|
| Top Right | Bottom Right | Top Left | Left | |
| Sensor | Sensor | Sensor | Sensor | Action |
| II | II | 0 | 0 | Move mouse to the |
| | | | | right |
| 0 | 0 | II | II | Move mouse to the |
| | | | | left |
| II | 0 | II | 0 | Move mouse up |
| 0 | II | 0 | II | Move mouse down |
| 0 | 0 | I | 0 | Left click |
| I | 0 | 0 | 0 | Right click |
| D | 0 | 0 | 0 | Switch from mouse |

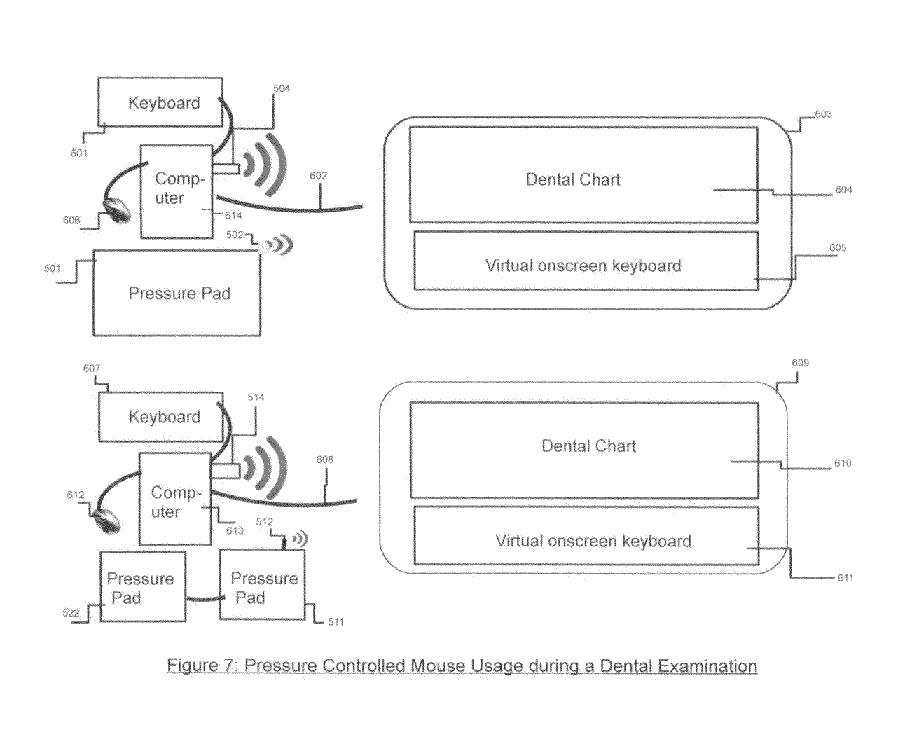

FIG. 7 illustrates Pressure Controlled Mouse Usage during a Dental Examination. During a dental examination the pressure controlled mouse can be used to retrieve and enter the patient data. This is similar to the Robotic surgery described above where the foot controlled mouse is used by a dentist or a dental hygienist to retrieve and enter patient examination information using their feet while their hands are occupied with the dental examination. The Pressure controlled mouse, 511, 522, or 501, 502, is coupled to a computer, 614 or 613, wirelessly as illustrated and is used as a foot controlled mouse to manipulate a dental information software operating on the computer.

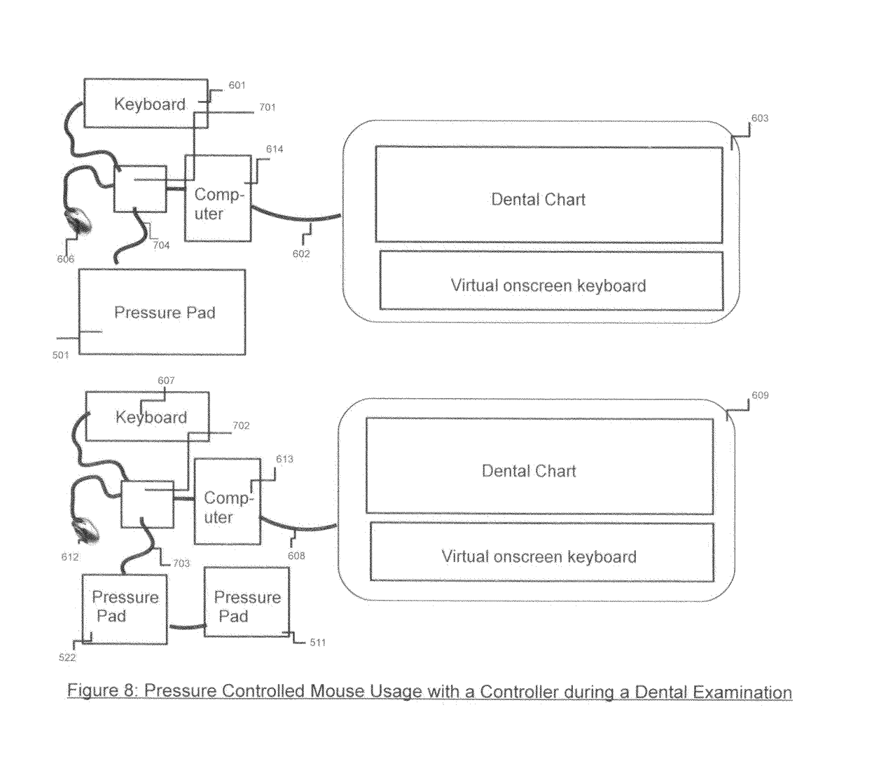

FIG. 8 illustrates Pressure Controlled Mouse Usage with a Controller during a Dental Examination. This diagram illustrates a controller, 701 or 702, that is used as hub that connects the Pressure controlled mouse, the keyboard, the computer mouse and other input accessories to the computer, 614 or 613. The Pressure controlled mouse's instructions as illustrated above are communicated by this controller to the computer that is running a dental information software.

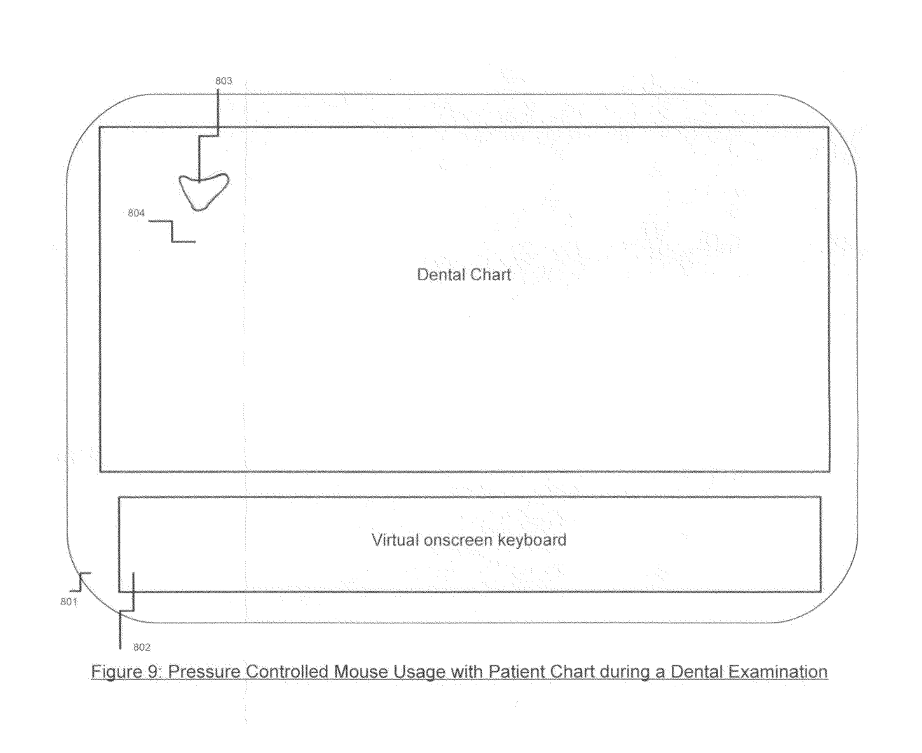

FIG. 9 illustrates Pressure Controlled Mouse Usage with Patient Chart during a Dental Examination. This figure illustrates an onscreen keyboard, 802, that can be controlled by the pressure controlled mouse to provide a full remote keyboard capability during dental examination or a robotic surgery or the like.

While the foregoing has been with reference to particular embodiments of the invention, it will be appreciated by those with ordinary skill in the art that changes in these embodiments may be made without departing from the principles and spirit of the invention.

With reference to the foregoing, I claim:

1. A foot operated mouse comprising a wireless communication device to communicate with a computer, and further comprising a pressure sensor to detect the mouse operations.
